(19) United States
(12) Patent Application Publication
(10) Pub. No.: US 2022/0148116 A1
(43) Pub. Date: May 12, 2022

(54) METHOD FOR IMPROVING THE ROUTING OF A FLEET OF MODULAR ELECTRIC VEHICLES

(71) Applicant: LUXEMBOURG INSTITUTE OF SCIENCE AND TECHNOLOGY, Esch-sur-Alzett (LU)

(72) Inventor: Wassila AGGOUNE-MTALAA, Esch-sur-Alzette (LU)

(73) Assignee: LUXEMBOURG INSTITUTE OF SCIENCE AND TECHNOLOGY, Esch-sur-Alzett (LU)

(21) Appl. No.: 17/415,604

(22) PCT Filed: Dec. 30, 2019
(86) PCT No.: PCT/EP2019/087165

§ 371 Date: Jun. 17, 2021

(30) Foreign Application Priority Data
Dec. 21, 2018 (EP) 18215390.8
Apr. 29, 2019 (LU) LU101202

(51) Int. Cl. G06Q 50/28; G07C 5/00; B60W 60/00; G06Q 10/06

(52) U.S. Cl. CPC G06Q 50/28; G06Q 10/06314; B60W 60/00256; G07C 5/008

(57) ABSTRACT

The invention provides a method for improving a delivery schedule for a fleet of modular electric vehicles, wherein each vehicle comprises a propulsion module having an electric propulsion system and a battery, and a set of trailer modules having a load capacity and a battery for providing electricity to said electric propulsion system, wherein each trailer module has an associated destination location and a destination time window. The proposed method is remarkable in that it is capable of taking into account multiple system constraints including random travel times using a genetic solving algorithm, and in that it is able to adapt the computation of delivery schedules to observed realizations of previously computed delivery schedules.

### TECHNICAL FIELD

The invention lies in the field of vehicle routing problems.

### BACKGROUND OF THE INVENTION

To preserve the environment and diminish dependence on fossil oil resources it has been proposed to use cleaner automotive vehicles, which produce less CO₂ emissions than traditionally known fuel-powered vehicles. An interesting alternative is provided by electric vehicles, which are powered by a rechargeable battery that supplies electric current to an electric engine. Local emissions are reduced to zero, while the overall emission footprint can be reduced by using clean electric power to recharge the automotive vehicle's battery. Logistics, including the delivery of goods and parcels from a source location to a destination location, relies heavily on a plethora of transportation means, including ships, airplanes and automotive vehicles, all of which are nowadays sources of nefarious emissions. It has been estimated that in 2010, roughly 20% of greenhouse gas emissions in the European Union, had been caused by transportation activities, while in the United States of America, the same sector contributed about 28% of greenhouse gas emissions. It has therefore been suggested to use electric commercial vehicles, ECV, for last-mile deliveries: an ECV transports the goods from the final distribution center of the logistics chain to the point of delivery at the destination location. Thereby, the greenhouse gas emissions are greatly reduced in the densely populated urban areas.

Modular electric transportation vehicles are of particular interest. A modular electric vehicle typically allows the first module, called cabin module, to carry or tow one or more further payload modules in order to transport more commodities. Each module provides a transportation volume and a distinct rechargeable battery. Given a set of delivery locations, it is therefore interesting to provide a routing schedule that allows all delivered goods to reach their destination within a predetermined time-frame using a fleet of modular electric vehicles. This target should be achieved while reducing the overall electric charge needed to put the routing schedule to practice. It is however difficult to put a theoretically planned routing schedule to practice given the often unforeseeable traffic, road or weather conditions that the modular electric vehicles are confronted with in the real world, and all of which have an impact on the routing schedule.

### Technical Problem to be Solved

It is an objective to present method and device, which overcome at least some of the disadvantages of the prior art.

### SUMMARY OF THE INVENTION

In accordance with a first aspect of the invention, a method for improving a delivery schedule for a fleet of modular electric vehicles is provided. Each vehicle comprises a propulsion module having an electric propulsion system and a battery, and a set of trailer modules having a load capacity and a battery for providing electricity to said electric propulsion system, and each trailer module has an associated destination location and a destination time window. The method comprises the steps of:
a) at a central computation unit, providing an initial delivery schedule starting at a common depot location, such that in accordance with said delivery schedule, each trailer module should reach its destination location within its destination time window given its available battery capacity;
b) using a data transmission unit, transmitting at least part of said delivery schedule to the respective vehicles of the fleet.

The method is remarkable in that the initial delivery schedule is computed based on random variables that represent the expected travel times between any two destination locations that are sequentially visited by a vehicle, and in that the probability distributions of said random variables are stored in a memory element of the central computation unit, and updated by said computation unit upon reception of an indication of the corresponding actual travel times experienced by said vehicles while driving in accordance with said delivery schedule, in order to take these travel times into account in future delivery schedule computations.

Preferably, the method may comprise repeating steps a) and b) at least once after the probability distributions of said random variables have been updated.

In accordance with an aspect of the invention, a method for improving delivery schedules for a fleet of modular electric vehicles is provided. Each vehicle comprises a propulsion module having an electric propulsion system and a battery, and a set of trailer modules having a load capacity and a battery for providing electricity to said electric propulsion system. Each trailer module has an associated destination location and a destination time window. The method comprises the steps of:
aa) at a central computation unit, computing a delivery schedule starting at a common depot location, such that in accordance with said delivery schedule, each trailer module should reach its destination location within its destination time window given its available battery capacity, the delivery schedule being computed based on random variables that represent the expected travel times between any two destination locations that are sequentially visited by a vehicle;
bb) using a data transmission unit transmitting at least part of said delivery schedule to the respective vehicles of the fleet;

The probability distributions of said random variables are stored in a memory element of the central computation unit, and updated by said computation unit upon reception of an indication of the corresponding actual travel times experienced by said vehicles while driving in accordance with said delivery schedule, in order to take these travel times into account in future delivery schedule computations. The method steps aa) and bb) are repeated at least once after the probability distributions of said random variables have been updated.

A trailer module may be left at a destination location, and it may be picked up by another modular vehicle arriving subsequently at the same destination location.

Preferably, the delivery schedule may be computed by considering stops of the modular vehicles either at a destination location or at a recharging location, for recharging said electric batteries of the propulsion and/or trailer modules.

The random variables may preferably initially follow a log-Normal probability distribution.

The probability distributions may preferably be updated by combining a histogram of observed travel time occurrences on a given route with said log-Normal distribution.

Preferably, the initial delivery schedule, or any subsequent delivery schedule, may be computed by the central computation unit by minimizing the objective function:

$$Min {\sum }_{k ∈ V , i ∈ {N}_{0}} {\sum }_{j ∈ {N}_{n + 1} , i \neq j} {c}_{i j}^{k} {x}_{i j}^{k} + {c}_{p} {\sum }_{j ∈ N} max \{ {g}_{j} - {b}_{j} , 0 \}$$

$$where {g}_{i =} \{ \begin{matrix}{a}_{i} & if {τ}_{i} < {a}_{i} \\ {τ}_{i} & if {τ}_{i} \geq {b}_{i}\end{matrix}$$

under a series of several constraints as follows:
assignment constraints:

$$\begin{matrix}{\sum }_{k ∈ V} {\sum }_{i ∈ {N}_{n + 1} , i \neq j} {x}_{i j}^{k} = 1 , ∀ i ∈ C & ( 2 ) \\ {\sum }_{k ∈ V} {\sum }_{i ∈ {N}_{n + 1} , i \neq j} {x}_{i j}^{k} \leq 1 , ∀ i ∈ R & ( 3 ) \\ {\sum }_{i ∈ {N}_{0} , i \neq j} {x}_{i j}^{k} - {\sum }_{i ∈ {N}_{n + 1} , i \neq j} {x}_{j i}^{k} = 0 , ∀ i ∈ R & ( 4 )\end{matrix}$$

modular constraints:

$$\begin{matrix}{λ}_{p}^{m} \leq {\sum }_{k ∈ V} {\sum }_{j ∈ N , p \neq j} {z}_{p j}^{k m} , ∀ m ∈ M , ∀ p ∈ N & ( 5 ) \\ 1 \leq {\sum }_{m ∈ M} {z}_{i j}^{k m} \leq N {b}_{mod} , ∀ k ∈ V , ∀ i ∈ {N}_{0} , ∀ j ∈ {N}_{n + 1} & ( 6 )\end{matrix}$$

time dependent constraints:

τᵢ+(max(sᵢ,hᵢ)+tᵢⱼ)xᵢⱼ^{k}−b₀(1−xᵢⱼ^{k})≤τⱼ,∀k∈V,∀i∈N₀,∀j∈Nₙ₊₁,i≠j (7)

τᵢ+tᵢⱼxᵢⱼ^{k}+w^{k}(E^{k}−yᵢ^{k})+(b₀w^{k}E^{k})(1−xⱼᵢ^{k})≤τⱼ,∀k∈V,∀i∈N₀,∀j∈Nₙ₊₁,i≠j (8)
capacity constraints:

0≤uⱼ^{j}≤uᵢ^{k}−q₁ xᵢⱼ^{k}+Q^{k}(1−xᵢⱼ^{k}), ∀k∈V,∀i∈N₀,∀j∈Nₙ₊₁,i≠j (9)

0≤uⱼ^{j}≤Q^{k}, ∀k∈V,∀j∈N_{0,n+1} (10)
electric constraints

$$\begin{matrix}ϵ \leq {y}_{j}^{k} \leq {y}_{i}^{k} {x}_{i j}^{k} ( 1 - {r}_{i}^{k} ) + {r}_{i}^{k} ( {w}^{k} {E}^{k} + {y}_{i}^{k} ) - {e}^{k} {d}_{i j} {x}_{i j}^{k} , \\ ∀ k ∈ V , ∀ i ∈ {N}_{0} , ∀ j ∈ {N}_{n + 1} , i \neq j & ( 11 ) \\ ϵ \leq {y}_{j}^{k} \leq {E}^{k} - ( {e}^{k} {d}_{i j} ) {x}_{i j}^{k} , \\ ∀ k ∈ V , ∀ i ∈ {N}_{0} , ∀ j ∈ {N}_{n + 1} , i \neq j & ( 12 ) \\ ϵ \leq {y}_{j}^{k} \leq {E}^{k} - {\sum }_{m ∈ M} {l}_{i}^{m} {z}_{i j}^{k m} , \\ ∀ k ∈ V , ∀ m ∈ M , i \neq j & ( 13 ) \\ {y}_{0}^{k} = {E}^{k} , ∀ k ∈ V & ( 14 )\end{matrix}$$

and wherein the parameters and variables are defined as follows:
Parameters:
0, n+1 Depot nodes;
N Set of nodes, comprising the set of destination locations and recharging locations;
V Set of modular vehicles;
M Set of modules comprising propulsion modules and trailer modules;
C Set of destination locations;
R Set of recharging stations;
R₀ Set of recharging stations including the depot:
dᵢⱼ Distance between node i and node j;
tᵢⱼ Uncertain travel time between node i and node j;
qᵢ Demand at destination location i;
aᵢ Earliest start-window at destination location i;
bᵢ Latest start-window at destination location i;
sᵢ Service time at destination location i;
hᵢ Recharging time at destination location i;
cᵢⱼ^{k} Travel cost of a vehicle of type k traversing the pair (i,j);
cₚ Penalty per unit of time delay;
e^{k} Energy consumption per unit of traveled distance by a vehicle of type k;
w^{k} Energy recharging cost per unit of time for a vehicle of type k;
E^{k} Maximum energy capacity of a vehicle of type k;
Nb_{mod} Maximum number of modules to be added;
Variables
τᵢ Time variable specifying the time of arrival at destination location i;
yᵢ^{k} Variable specifying the remaining charge of vehicle k at destination location i;
lᵢ^{m} Variable specifying the remaining charge of module m at destination location i;
uᵢ^{k} Variable specifying the remaining load of vehicle k at destination location i;
gᵢ Random starting time at node i;
Decision variables
xᵢⱼ^{k} Equal to 1 if a vehicle of type k travels from destination location i to destination location j, 0 otherwise;
zᵢⱼ^{km} Equal to 1 if a vehicle of type k transports module m from node i to node j, 0 otherwise;
λᵢ^{m} Equal to 1 if destination location i is served by module m, 0 otherwise;
rᵢ^{k} Equal to 1 if a vehicle of type k recharges at destination location i, 0 otherwise.

Preferably, the minimization of said objective function may comprise using the central computation unit to:
draw S samples of said random variables, each sample being of size N and representing random arrival times at destination location and/or recharging locations, and storing said samples in a memory element;
compute S values of said objective function ƒ_{N}¹, ƒ_{N}², . . . ƒ_{N}^{S}, a by solving the problem (1) repeatedly using a genetic algorithm;
compute an average value of the optimal solutions as

$$= \frac{1}{S} {\sum }_{S = 1}^{S} {f}_{N}^{S} ( {\tilde{x}}^{S} , {Sa}_{S} ( p ) ,$$

wherein \tilde{x}¹, \tilde{x}², . . . \tilde{x}^{S} are candidate solutions, and Saₕ(p) is the h-th sampling of the stochastic parameters.

Each modular vehicle may preferably transmit information providing an indication of the actual residual battery charge of each module to the central computation unit at least once as it drives in accordance with the delivery schedule.

Preferably, only data describing a specific vehicle's route, as provided by a computed delivery schedule, may be transmitted to the corresponding vehicle.

The method may further preferably comprise the step of, at the modular vehicle, autonomously driving in accordance with said delivery schedule.

The method may further preferably comprise the step of, at the modular vehicle, displaying at least part of said delivery schedule on a display unit.

The indication of the corresponding actual travel times experienced by said vehicle may preferably be measured by a timing unit of the vehicle and transmitted to the central computing unit by the vehicle.

The indication of the corresponding actual travel times experiences by said vehicle may preferably be measured using a satellite-based geolocation service, such as the Global Positioning System, GPS, or Galileo.

In accordance with another aspect of the invention, a computing device is provided. The computing device comprises a data processing unit, a data transmission unit and at least one memory element operatively connected to the data processing unit, wherein
data describing a fleet of modular electric vehicles, each vehicle comprising a propulsion module having an electric propulsion system and a battery, and a set of trailer modules having a load capacity and a battery for providing electricity to said electric propulsion system, is provided in a memory element;
data describing a plurality of destination locations and destination time windows is provided in a memory element, wherein said trailer modules are associated with said destination locations and time windows;
data describing an initial delivery schedule starting at a common depot location, such that each trailer module reaches its destination location within its destination time window given its available battery capacity is provided in a memory element.

The data transmission unit is configured to transmit at least part of said delivery schedule to the respective vehicles of the fleet. The initial delivery schedule is based on random variables that represent the expected travel times between any two destination locations that are sequentially visited by a vehicle. The data processing unit is configured for updating said probability distributions of said random variables upon reception of an indication of the corresponding actual travel times experienced by said vehicles while driving in accordance with said delivery schedule, in order to take these travel times into account in future delivery schedule computations.

In accordance with an aspect of the invention, a computing device comprising a data processing unit, a data transmission unit and at least one memory element operatively connected to the data processing unit is proposed, wherein
data describing a fleet of modular electric vehicles, each vehicle comprising a propulsion module having an electric propulsion system and a battery, and a set of trailer modules having a load capacity and a battery for providing electricity to said electric propulsion system, is provided in a memory element;
data describing a plurality of destination locations and destination time windows is provided in a memory element, wherein said trailer units are associated with said destination locations and time windows;
data describing a delivery schedule starting at a common depot location, such that each trailer module reaches its destination location within its destination time window given its available battery capacity is provided in a memory element.

The data transmission unit is configured to transmit at least part of said delivery schedule to the respective vehicles of the fleet, and
the delivery schedule is based on random variables that represent the expected travel times between any two destination locations that are sequentially visited by a vehicle, and in that
the data processing unit is configured for updating said probability distributions of said random variables upon reception of an indication of the corresponding actual travel times experienced by said vehicles while driving in accordance with said delivery schedule, in order to take these travel times into account in future delivery schedule computations;
the data processing unit is configured for calculating at least one further delivery schedule after the probability distributions of said random variables have been updated, and for transmitting at least part of said delivery schedule to the respective vehicles of the fleet.

The memory element may be physically remote to the data processing unit and accessible via a data communication channel. The memory element may comprise a Random-Access Memory, RAM, module, a Hard Disk Drive, HDD, or a Solid-State Drive, SSD. It may comprise a structured memory element, such as a database.

The data processing unit may comprise a central processing unit, CPU, of a computing device. The data transmission unit may preferably comprise a data networking interface operatively coupled to said data processing unit, and adapted to transmit data via a wireless data communication channel to a modular vehicle.

Preferably, the data processing unit may be further configured to perform the method steps in accordance with any of the previous aspects of the invention.

In accordance with a further aspect of the invention, a computer program is provided. The computer program comprises computer readable code means, which when run on a computer, causes the computer to carry out the method according to aspects of the invention.

According to a final aspect of the invention, a computer program product is provided. The computer program product comprises computer-readable medium on which the computer program according to aspects of the invention is stored.

By using the method in accordance with aspects of the invention, it becomes possible to more accurately model the travel times experienced by a fleet of electrical modular vehicles, in which each module has its dedicated battery and delivery charge. This is achieved by modelling the travel times as random variables and by combining a log-Normal distribution with real-world observations of the corresponding travel times. The proposed method is capable of dynamically adapting the probability distributions of the random variables to road conditions, which are reflected by systematic observed deviations from the expected travel times. By doing so, the method allows to deploy a modular electric vehicle fleet in realistic conditions, so as to minimize the overall cost, to meet a pre-determined timing and to minimize the overall electrical charge required by the fleet, without resorting to external geographical data such as traffic maps. By implementing the proposed method, the computing system that runs the method is automatically updated and adapted in such a way that the future routes it computes for the fleet of vehicles become better matched to the real-world road conditions. Iteratively, the probability distributions that are estimated based on observed travel times provide an improving model of the real world conditions. Therefore the method progressively improves the possibility of putting a theoretically planned routing schedule to practice given the traffic, road or weather conditions that the modular electric vehicles are confronted with in the real world.

### BRIEF DESCRIPTION OF THE DRAWINGS

Several embodiments of the present invention are illustrated by way of figures, which do not limit the scope of the invention, wherein:

FIG. 1 illustrates the concepts in accordance with a preferred embodiment of the method and system in accordance with the invention;

FIG. 2 illustrates routes as provided by a delivery schedule generated by a preferred embodiment of the method in accordance with the invention;

FIG. 3 illustrates a chromosome or candidate solution as provided by the genetic algorithm used in accordance with embodiments of the invention.

### DETAILED DESCRIPTION OF THE INVENTION

This section describes aspects of the invention in further detail based on preferred embodiments and on the figures. The figures do not limit the scope of the invention.

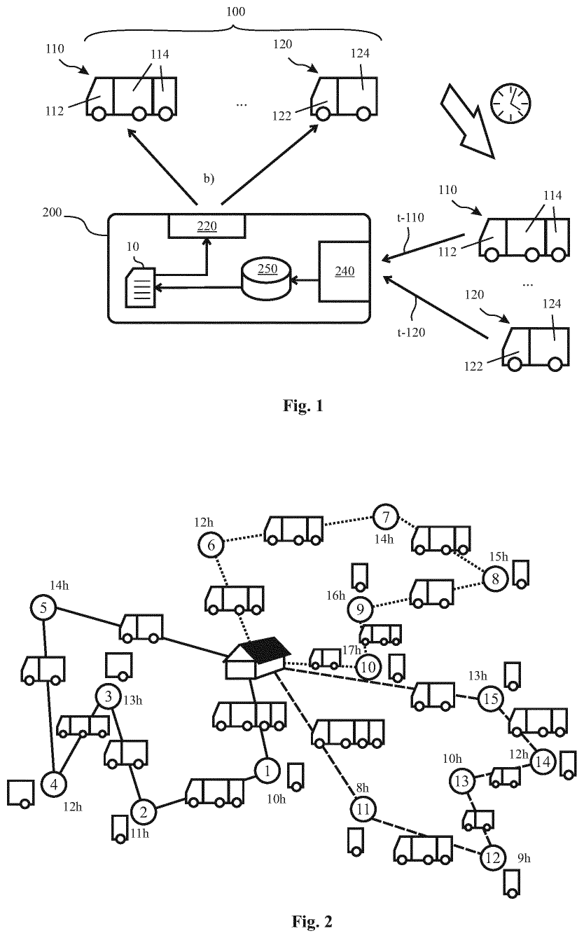

An example of a system in which the invention is used is illustrated in FIG. 1. The invention considers a fleet 100 modular electric vehicles 110, 120 for urban distribution of goods. Indeed, this concept is founded on a modular and active frame design for the vehicle which allows the first module, called a propulsion or cabin module 112, 122, to carry one or multiple modules in order to bring more commodities. First, a modular vehicle is as its name suggests, made up of a cabin/propulsion module managed by a driver, followed by a (possibly empty) set of trailer units 114, 124. Alternatively, the propulsion module may be configured for autonomous driving. Typically, the propulsion module is equipped with an electrical motor driving at least one axle. The electrical motor is coupled to the batteries of each of the vehicle's modules. The propulsion module may be pushing the trailer unit or towing them. It is equipped with a computing device and data transmission/reception means, for communicating with a remote central computing unit 200. Each module 112, 114, 122, 124 has its own battery and is autonomous in terms of consumption and electric charging. Moreover, it may be assumed that the modules can be of the same volume and therefore carry the same amount of goods.

FIG. 2 describes possible solutions related with new logistics schemes for urban distribution using electric modular vehicles. One solution is defined by the solid-lined route. First, the vehicle leaves the depot with utmost three modules, serves the first customer at 10 AM and releases the last module at this customer location. Thereafter, it visits the next customer who has to be served at 11 AM, and releases there another payload module. In this case, the vehicle performs the rest of its tour with only one module. Then, the vehicle has to serve another customer before 1 PM. When it reaches this location, it retrieves a module let by another modular vehicle earlier in the day and pursues its route with two payload modules. Thereafter, it goes to another customer who should be delivered at 12 AM. It releases there a payload module and returns to the depot with only the cabin module. At the end of the studied period, all the modules (propulsion and trailer units) should be back to the depot.

Given a set of customers associated with destination locations, which have known demands, and a heterogeneous fleet of electric modular vehicles starting from a localized depot, the aim is to compute routes that begin and end at this depot, such that all the needs at the destination locations are fulfilled and the capacity of the fleet as well as the timing constraints are respected.

Formally, let G=(N,A) be a complete directed graph where N denotes a set of nodes. We have N=C∪R consisting of a set of destination locations C and a set of recharging stations R. Further, let nodes 0 and n+1 represent the beginning and end of the tour respectively, i.e., N={0}∪{1, . . . , n}∪{n+1}. Thus, let A⊆N×N, denotes the arc set with A={(i,j)|i,j∈N,i≠j}. Each arc (i,j) is associated with an uncertain travel time tᵢⱼ and a distance dᵢⱼ. Each vehicle of type k, when it crosses an arc, consumes the amount e^{k}dᵢⱼ of the remaining battery charge, where e^{k} denotes the energy consumption per distance unit travelled. A fleet of heterogeneous vehicles is stationed at the depot. Before leaving, each electric vehicle must be fully charged at the maximum recharge quantity E^{k}. Each customer located at node i∈N has a positive demand qᵢ, a service time sᵢ, a time window [aᵢ,bᵢ] and a recharging time hᵢ. The proposed model is based on the use of electric vehicles. For this reason, planning a trip with these vehicles requires the consideration of some assumptions linked with both the charging infrastructure and the charging policy.

Some hypothesis have been set in order to define properly the problem. These assumptions are related basically to the recharging policy.
The depot can be used as a recharging station and all the vehicles must be fully charged when they leave the depot. Vehicles may need to recharge their battery at customer locations in order to continue a tour.
The vehicle recharges at a customer location if the battery charge level drops below a given threshold.
Recharging at customer locations requires a joint agreement with owners, in respect to rates and to charging times.
The recharging time depends on the remaining energy when arriving at the recharging station.
If the service time is not yet finished, the vehicle remains in charge even if the charge level of the battery is above the threshold. Otherwise, if it is below the threshold, the vehicle will recharge until this threshold and a penalty is added to the objective function.

The arrival time at destination locations are modelled as random variables. The random variables may be drawn in accordance with a log-Normal probability distribution, which has been shown to provide a good match for modelling travel times in urban traffic. As will be explained, the probability distributions are preferably adapted over time, so that the computational model is refined and more closely matches the settings encountered by the modular electric vehicles.

In what follows, it is proposed that a delivery schedule, comprising delivery routes for all modular vehicles 110, 120 of a fleet 100, is computed at a central computation unit. Reference is made to FIG. 1. The computation unit 200 may be a single computing device configured through appropriate software to resolve the delivery routing problem that will be set out here below. Alternatively, the computation unit may be provided as a cluster of distributed computing devices, which interact using a data communication network. The computation unit has access to memory elements in which data describing a fleet of modular electric vehicles, wherein each vehicle comprises a propulsion module having an electric propulsion system and a battery, and a set of trailer modules having a load capacity and a battery for providing electricity to said electric propulsion system. Each trailer module 114, 124 has an associated destination location and a destination time window:

An initial delivery schedule 10 is provided at the central computing unit. The initial schedule may be computed by solving the problem set out here below, or it may be pre-stored in a memory element 250 and read therefrom by the computing unit. The initial delivery schedule is based on random travel times for each route connecting two subsequent destination locations. The delivery schedule comprises routes for each vehicle 110, 120 of the fleet, starting at a common depot location, such that in accordance with said delivery schedule, each trailer module 114, 124 should reach its destination location within its destination time window given its available battery capacity.

At least part of said delivery schedule 10 is transmitted from the computing unit to the respective vehicles of the fleet. This is depicted by step b) in FIG. 2. Preferably, only the route (i.e., sequence destination location) that is assigned to a given vehicle is transmitted to that particular vehicle, which may preferably display it on a display unit, or which may use it as an input to a navigation system or to guide an autonomous driving system.

The initial delivery schedule 10 is computed based on random variables that represent the expected travel times between any two destination locations that are subsequently visited by a vehicle. The probability distributions of said random variables are stored in a memory element 250 of the central computation unit, and updated by said computation unit upon reception, using a data receiving unit 240, of an indication of the corresponding actual travel times t-110, t-120 experienced by said vehicles 110, 120 while driving in accordance with said delivery schedule 10, in order to take these travel times into account in future delivery schedule computations. The travel times may be logged and transmitted to the central computation unit by clocks in the vehicles themselves, or the fleet may be monitored by a satellite geo-positioning system, from which arrival/travel times may be inferred. For example, the central computing unit may keep a histogram in a memory element for each pair of destination locations, in which observed travel times for the corresponding route are counted. The non-empty bins of the resulting histogram may be combined, for example through a weighting function, with the corresponding samples of the log-Normal probability distribution. While maintaining features of the theoretical model, this combination with real-world observations allows the system to take into account systematic variations in the travel times on a given route, which may arise due to peak traffic hours, road works or weather conditions. As the travel-time updates are preferably gathered each time the fleet is operational, an up-to-date dynamic profile of the overall travel times may be obtained without resorting to actual geographical routing data or external traffic information sources. By using the updated probability distributions for future computations, the resulting future delivery schedules 10 will be more accurate and they will result in a more efficient use of the available electrical energy and load capacity.

In accordance with embodiments of the invention, the feedback t-110, t-120 provided by the actual implementation of a computed delivery schedule, may further include other observed parameters, such as the observed residual battery charges for each module at each destination. This allows the central computation 200 unit to rely on up-to-date date and battery capacities in future delivery schedule computations. This approach may for example implicitly be used to take into account (or identify) a diminished maximum capacity of a battery, or a battery that drains faster than expected. This information is exploited by the computation unit to provide more accurate future delivery schedules, but it may as well be used to detect maintenance need of the electric modules.

The problem solved by aspects of the invention may be formalized as follows:
Parameters:
0, n+1 Depot nodes;
N Set of nodes, comprising the set of destination locations and recharging locations;
V Set of modular vehicles;
M Set of modules comprising propulsion modules and trailer modules;
C Set of destination locations;
R Set of recharging stations;
R₀ Set of recharging stations including the depot:
dᵢⱼ Distance between node i and node j;
tᵢⱼ Uncertain travel time between node i and node j;
qᵢ Demand at destination location i;
aᵢ Earliest start-window at destination location i;
bᵢ Latest start-window at destination location i;
sᵢ Service time at destination location i;
hᵢ Recharging time at destination location i;
cᵢⱼ^{k} Travel cost of a vehicle of type k traversing the pair (i,j);
cₚ Penalty per unit of time delay;
e^{k} Energy consumption per unit of traveled distance by a vehicle of type k;
w^{k} Energy recharging cost per unit of time for a vehicle of type k;
E^{k} Maximum energy capacity of a vehicle of type k;
Nb_{mod} Maximum number of modules to be added;
Variables
τᵢ Time variable specifying the time of arrival at destination location i;
yᵢ^{k} Variable specifying the remaining charge of vehicle k at destination location i;
lᵢ^{m} Variable specifying the remaining charge of module m at destination location i;
uᵢ^{k} Variable specifying the remaining load of vehicle k at destination location i;
gᵢ Random starting time at node i;
Decision variables
xᵢⱼ^{k} Equal to 1 if a vehicle of type k travels from destination location i to destination location j, 0 otherwise;
zᵢⱼ^{km} Equal to 1 if a vehicle of type k transports module m from node i to node j, 0 otherwise;
λᵢ^{m} Equal to 1 if destination location i is served by module m, 0 otherwise;
rᵢ^{k} Equal to 1 if a vehicle of type k recharges at destination location i, 0 otherwise.

Mathematical Formulation

Minimization of the Objective Function

$$Min {\sum }_{k ∈ V , i ∈ {N}_{0}} {\sum }_{j ∈ {N}_{n + 1} , i \neq j} {c}_{i j}^{k} {x}_{i j}^{k} + {c}_{p} {\sum }_{j ∈ N} max \{ {g}_{j} - {b}_{j} , 0 \} \\ Where \\ {g}_{i =} \{ \begin{matrix}{a}_{i} & if {τ}_{i} < {a}_{i} \\ {τ}_{i} & if {τ}_{i} \geq {b}_{i}\end{matrix} \qquad ( 1 )$$

Under a series of several constraints as follows:
Assignment constraints

$$\begin{matrix}{\sum }_{k ∈ V} {\sum }_{i ∈ {N}_{n + 1} , i \neq j} {x}_{i j}^{k} = 1 ∀ i ∈ C & ( 2 ) \\ {\sum }_{k ∈ V} {\sum }_{i ∈ {N}_{n + 1} , i \neq j} {x}_{i j}^{k} \leq 1 ∀ i ∈ R & ( 3 ) \\ {\sum }_{i ∈ {N}_{0} , i \neq j} {x}_{i j}^{k} - {\sum }_{i ∈ {N}_{n + 1} , i \neq j} {x}_{j i}^{k} = 0 ∀ i ∈ R & ( 4 )\end{matrix}$$

Modular constraints

$$\begin{matrix}{λ}_{p}^{m} \leq {\sum }_{k ∈ V} {\sum }_{j ∈ N , p \neq j} {z}_{p j}^{k m} ∀ m ∈ M , \\ ∀ p ∈ N & ( 5 ) \\ 1 \leq {\sum }_{m ∈ M} {z}_{i j}^{k m} \leq N {b}_{mod} ∀ k ∈ V , \\ ∀ i ∈ {N}_{0} , ∀ j ∈ {N}_{n + 1} & ( 6 )\end{matrix}$$

Time dependent constraints

τᵢ+(max(sᵢ,hᵢ)+tᵢⱼ)xᵢⱼ^{k}−b₀(1−xᵢⱼ^{k})≤τⱼ ∀k∈V,∀i∈N₀,∀j∈Nₙ₊₁,i≠j (7)

τᵢ+tᵢⱼxᵢⱼ^{k}+w^{k}(E^{k}−yᵢ^{k})+(b₀w^{k}E^{k})(1−xⱼᵢ^{k})≤τⱼ ∀k∈V,∀i∈N₀,∀j∈Nₙ₊₁,i≠j (8)
Capacity constraints

$$\begin{matrix}0 \leq {u}_{j}^{k} \leq {u}_{i}^{k} - {q}_{i} {x}_{i j}^{k} + {Q}^{k} ( 1 - {x}_{i j}^{k} ) ∀ k ∈ V , \\ ∀ i ∈ {N}_{0} , ∀ j ∈ {N}_{n + 1} , i \neq j & ( 9 ) \\ 0 \leq {u}_{j}^{k} \leq {Q}^{k} ∀ k ∈ V , \\ ∀ j ∈ {N}_{0 , n + 1} & ( 10 )\end{matrix}$$

Electric constraints

$$\begin{matrix}ϵ \leq {y}_{j}^{k} \leq {y}_{i}^{k} {x}_{i j}^{k} ( 1 - {r}_{i}^{k} ) + {r}_{i}^{k} ( {w}^{k} {E}^{k} + {y}_{i}^{k} ) - {e}^{k} {d}_{i j} {x}_{i j}^{k} ∀ k ∈ V , \\ ∀ i ∈ {N}_{0} , ∀ j ∈ {N}_{n + 1} , i \neq j & ( 11 ) \\ ϵ \leq {y}_{j}^{k} \leq {E}^{k} - ( {e}^{k} {d}_{i j} ) {x}_{i j}^{k} ∀ k ∈ V , \\ ∀ i ∈ {N}_{0} , ∀ j ∈ {N}_{n + 1} , i \neq j & ( 12 ) \\ ϵ \leq {y}_{j}^{k} \leq {E}^{k} - {\sum }_{m ∈ M} {l}_{i}^{m} {z}_{i j}^{k m} ∀ k ∈ V , \\ ∀ m ∈ M , i \neq j & ( 13 ) \\ {y}_{0}^{k} = {E}^{k} ∀ k ∈ V & ( 14 )\end{matrix}$$

Constraint (2) ensures that each customer is served exactly once and exactly by one vehicle while constraint (3) ensures that each recharging station will have at most one successor node: a customer, a recharging station or the depot. Furthermore, constraint (4) ensures that for each node, the number of arrivals must equal the number of departures. In addition, the constraint described in (5) ensures that if the module m serves customer p, then module m should leave customer p to serve customer j. In constraint (6) we enforce that each vehicle may carry a predefined number of modules at most at any given time and to move forward the cabin module, the vehicle should at least bring one payload module. The problem may alternatively be solved in order to determine the maximum number of modules per vehicle given the remaining constraints. Constraints (7) and (8) guarantee the elimination of subtours. Moreover, constraints (9) and (10) are dedicated to capacity constraints. The constraint depicted in (9) ensures that the load at node j depends on the load at node i which takes into account the demand qᵢ, while constraint (10) ensures that the load u^{k}ⱼ should not exceed the capacity Q^{k} of the vehicle. Thereafter, the electric constraints are described by the constraints (11)-(13). Constraint (11) ensures that the charge level of the vehicle in the node j depends on the energy consumed when it crosses the arc (i,j). Constraint (12) specifies that the remainder of the charge in node j is equal to the maximum load of the battery less the charge consumed along the arc (i,j). Constraint (13) ensures that the level of electrical charge of the overall vehicle including the attached modules must not fall below a given threshold. Finally, in (14) we enforce that the vehicle must be fully charged when it leaves the depot.

An instance of this model may for example be resolved using the commercially available solver called Cplex™, which uses the Branch and Bound technique to solve the problem.

Preferably, instances of the model may be solved by resorting to a genetic algorithm. In recent decades, several studies were conducted to compare the genetic algorithms, GA, to other metaheuristic algorithms. The most important advantage of GA compared to other metaheuristic approaches is that GA proved to be an efficient method by outputting adequate (good enough) solutions and good results in an acceptable time. For that reason, genetic algorithms are well used to solve combinatorial optimization problem and especially NP hard problems. Therefore, it is proposed to chose the genetic algorithm that has already proven its performance on routing transportation problems, see S. Karakatic and V. Podgorelec, “A survey of genetic algorithms for solving multi depot vehicle routing problem” Applied Soft Computing, vol. 27, pp. 519-532, 2014, and H. Nazif and L. S. Lee, “Optimized Crossover Genetic Algorithm for Vehicle Routing Problem with Time Windows” American Journal of Applied Sciences, vol. 7, no. 1, pp. 95-101, 2010.

In practice, there are several ways to generate an initial population, to select the best individual from the population and to diversify the population over generations. However, all GA methods should have a good representation of an individual, appropriate evaluation function and especially good genetic operators.

A. Genetic Representation and Encoding

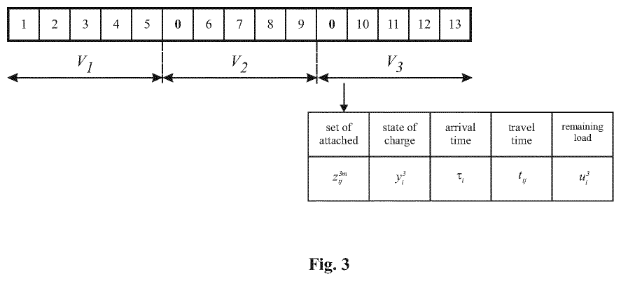

Like in most GAs for Vehicle Routing problems, see for example, S. Tasan and A. M. Gen, “A genetic algorithm based approach to vehicle routing problem with simultaneous pick-up and deliveries” Computers and Industrial Engineering, vol. 62, pp. 755-761, 2012 or Z. Wang, H. Duan and X. Zhang, “An Improved Greedy Genetic Algorithm for Solving Travelling Salesman Problem” IEEE International Conference on Natural Computation, vol. 5, pp. 374-378, 2009, a chromosome or candidate solution is represented with an array of n customer nodes which are served by the vehicles. This representation appears to be the most used and the simplest one. However, the weakness of this permutation is that there is no indication from which route and with which vehicle the customer is served. Therefore, we have chosen to use the representation depicted in FIG. 3 complemented with the depot index 0 in the genotype. The provided example is unrelated to the routes depicted in FIG. 2.

An integer sequence [1, . . . , 13] represents the destination locations while the index 0 is dedicated to the depot. Route 1 of vehicle V1 starts at the depot, visits customers 1, 2, 3, 4 and 5 and goes back to the depot. Route 2 of vehicle V2 starts from the depot to customers 6, 7, 8 and 9. Finally, route 3 of vehicle V3 begins from the depot and visits the last four customers 10 to 13. Each vehicle is characterized by its set of attached modules, its state of charge, its uncertain arrival time, its travel time and the remaining load.

B. Initial Population Construction

To generate an initial population, a constructive heuristic is used in order to create a list of customers visited by each vehicle. One popular way to generate an initial solution is to use a greedy algorithm. The main idea is to start from an empty initial solution and add incrementally the solution components taking into account the previous choices until a complete solution is obtained. It is proposed to choose at each step the nearest customer to the customers already visited, while ensuring that capacity constraints as well as timing constraints are respected. The greedy algorithm provides a single initial solution. Therefore, to generate an initial population, an improvement heuristic called 2-opt exchange is proposed, which consists of eliminating two edges from our initial solution obtained by the greedy algorithm and reconnecting the two resulting routes differently to obtain a new path. Thus, the heuristic 2-opt exchange can modify differently the route by rearranging a pair of edges. The other characteristics of the used genetic algorithm are as follows.

C. Fitness Function

The fitness function measures the quality of the represented solutions. Once individuals are created, they are ranked as per their fitness value calculated as the sum of the total distance travelled, and the penalty costs.

D. Selection

The tournament selection is used in our proposed approach, where the numbers of randomly picked individuals compete in the tournament. The main idea consists in running several tournaments among a few individuals randomly selected from the population. The best individuals of each tournament with the best fitness value are selected to generate new offsprings in the next phase.

E. Crossover

Crossover is the process that allows in nature the production of chromosomes, which partially inherit the characteristics of the parents in order to produce offsprings. In this purpose, we are interested to apply a Partial Mapping Crossover, PMX, because it has the advantage of providing best solutions in a short time frame among others operators.

F. Mutation

The mutation always improves the search process by helping to escape from local minima. Therefore, the insertion mutation is proposed, where the main idea is to remove the node from its place and insert it at another randomly chosen place on the route or possibly in another different route.

In order to adapt the genetic algorithm to the stochastic travelling times, a sample average approximation approach is proposed. Therein, the minimization of objective function (1) comprises using the central computation unit to:
draw S samples of said random variables, each sample being of size N and representing random arrival times at destination location and/or recharging locations, and storing said samples in a memory element;
compute S values of said objective function ƒ_{N}¹, ƒ_{N}², . . . ƒ_{N}^{S}, a by solving the problem (1) repeatedly using a genetic algorithm;
compute an average value of the optimal solutions as

$$= \frac{1}{S} {\sum }_{S = 1}^{S} {f}_{N}^{S} ( {\tilde{x}}^{S} , {Sa}_{S} ( p ) ,$$

wherein \tilde{x}¹, \tilde{x}², . . . \tilde{x}^{S} are candidate solutions, and Saₕ(p) is the h-th sampling of the stochastic parameters.

The candidate solutions are obtained by applying the genetic algorithm to the problem in which the travel times are replaced by stochastic values respecting the log-normal (or correspondingly updated) probability distribution.

It should be noted that features described for a specific embodiment described herein may be combined with the features of other embodiments unless the contrary is explicitly mentioned.

Based on the description and figures that has been provided, a person with ordinary skills in the art will be enabled to develop a computer program for implementing the described methods without undue burden.

It should be understood that the detailed description of specific preferred embodiments is given by way of illustration only, since various changes and modifications within the scope of the invention will be apparent to the person skilled in the art. The scope of protection is defined by the following set of claims.

1. A method for improving delivery schedules for a fleet of modular electric vehicles, wherein each vehicle comprises a propulsion module having an electric propulsion system and a propulsion battery, and a set of trailer modules, wherein each trailer module has a load capacity and a trailer module battery for providing electricity to said electric propulsion system,
wherein each trailer module has an associated destination location and a destination time window, the method comprising the steps of:
a) computing a delivery schedule at a central computation unit starting at a common depot location, such that in accordance with said delivery schedule, each trailer module reach their respective destination locations within their respective destination time window given its available battery capacity, the delivery schedule being computed based on random variables that represent the expected travel times between any two destination locations that are sequentially visited by a vehicle;
b) transmitting at least part of said delivery schedule to the respective vehicles of the fleet using a data transmission unit; wherein
the probability distributions of said random variables are stored in a memory element of the central computation unit, and updated by said computation unit upon reception of an indication of the corresponding actual travel times experienced by said vehicles while driving in accordance with said delivery schedule, in order to take these travel times into account in future delivery schedule computations; and
steps a) and b) are repeated at least once after the probability distributions of said random variables have been updated.

2. The method of claim 1, wherein said delivery schedule is computed by considering stops of the modular vehicles either at a destination location or at a recharging location, for recharging said electric propulsion batteries and/or trailer modules batteries.

3. The method of claim 1, wherein said random variables initially follow a log-Normal probability distribution.

4. The method of claim 2, wherein the initial delivery schedule, or any subsequent delivery schedule, is computed by the central computation unit by minimizing the objective function:
$$Min {\sum }_{k ∈ V , i ∈ {N}_{0}} {\sum }_{j ∈ {N}_{n + 1} , i \neq j} {c}_{i j}^{k} {x}_{i j}^{k} + {c}_{p} {\sum }_{j ∈ N} max \{ {g}_{j} - {b}_{j} , 0 \}$$
$$where$$
$${g}_{i} = \{ \begin{matrix}{a}_{i} & if {τ}_{i} < {a}_{i} \\ {τ}_{i} & if {τ}_{i} \geq {b}_{i}\end{matrix}$$
under a series of several constraints as follows:
assignment constraints:
$$\begin{matrix}{\sum }_{k ∈ V} {\sum }_{i ∈ {N}_{n + 1} , i \neq j} {x}_{i j}^{k} = 1 , \\ ∀ i ∈ C & ( 2 ) \\ {\sum }_{k ∈ V} {\sum }_{i ∈ {N}_{n + 1} , i \neq j} {x}_{i j}^{k} \leq 1 , \\ ∀ i ∈ R & ( 3 ) \\ {\sum }_{i ∈ {N}_{0} , i \neq j} {x}_{i j}^{k} - {\sum }_{i ∈ {N}_{n + 1} , i \neq j} {x}_{j i}^{k} = 0 , \\ ∀ i ∈ R & ( 4 )\end{matrix}$$
modular constraints:
$$\begin{matrix}{λ}_{p}^{m} \leq {\sum }_{k ∈ V} {\sum }_{j ∈ N , p \neq j} {z}_{p j}^{k m} , \\ ∀ m ∈ M , ∀ p ∈ N & ( 5 ) \\ 1 \leq {\sum }_{m ∈ M} {z}_{i j}^{k m} \leq N {b}_{mod} , \\ ∀ k ∈ V , ∀ i ∈ {N}_{0} , ∀ j ∈ {N}_{n + 1} & ( 6 )\end{matrix}$$
time dependent constraints:
τᵢ+(max(sᵢ,hᵢ)+tᵢⱼ)xᵢⱼ^{k}−b₀(1−xᵢⱼ^{k})≤τⱼ,∀k∈V,∀i∈N₀,∀j∈Nₙ₊₁,i≠j (7)
τᵢ+tᵢⱼxᵢⱼ^{k}+w^{k}(E^{k}−yᵢ^{k})+(b₀w^{k}E^{k})(1−xⱼᵢ^{k})≤τⱼ,∀k∈V,∀i∈N₀,∀j∈Nₙ₊₁,i≠j (8)
capacity constraints:
0≤uⱼ^{k}≤uᵢ^{k}−qᵢxᵢⱼ^{k}+Q^{k}(1−vᵢⱼ^{k}),∀k∈V,∀i∈N₀,∀j∈Nₙ₊₁,i≠j (9)
0≤uⱼ^{k}≤Q^{k},∀k∈V,∀j∈N_{0,n+1} (10)
electric constraints
$$\begin{matrix}ϵ \leq {y}_{j}^{k} \leq {y}_{i}^{k} {x}_{i j}^{k} ( 1 - {r}_{i}^{k} ) + {r}_{i}^{k} ( {w}^{k} {E}^{k} + {y}_{i}^{k} ) - {e}^{k} {d}_{i j} {x}_{i j}^{k} , \\ ∀ k ∈ V , ∀ i ∈ {N}_{0} , ∀ j ∈ {N}_{n + 1} , i \neq j & ( 11 ) \\ ϵ \leq {y}_{j}^{k} \leq {E}^{k} - ( {e}^{k} {d}_{i j} ) {x}_{i j}^{k} , \\ ∀ k ∈ V , ∀ i ∈ {N}_{0} , ∀ j ∈ {N}_{n + 1} , i \neq j & ( 12 ) \\ ϵ \leq {y}_{j}^{k} \leq {E}^{k} - {\sum }_{m ∈ M} {l}_{i}^{m} {z}_{i j}^{k m} , \\ ∀ k ∈ V , ∀ m ∈ M , i \neq j & ( 13 ) \\ {y}_{0}^{k} = {E}^{k} , ∀ k ∈ V & ( 14 )\end{matrix}$$
and wherein the parameters and variables are defined as follows:
Parameters:
0, n+1 Depot nodes;
N Set of nodes, comprising the set of destination locations and recharging locations;
V Set of modular vehicles;
M Set of modules comprising propulsion modules and trailer modules;
C Set of destination locations;
R Set of recharging stations;
R₀ Set of recharging stations including the depot:
dᵢⱼ Distance between node i and node j;
tᵢⱼ Uncertain travel time between node i and node j;
qᵢ Demand at destination location i;
aᵢ Earliest start-window at destination location i;
bᵢ Latest start-window at destination location i;
sᵢ Service time at destination location i;
hᵢ Recharging time at destination location i;
cᵢⱼ^{k} Travel cost of a vehicle of type k traversing the pair (i,j);
cₚ Penalty per unit of time delay;
e^{k} Energy consumption per unit of traveled distance by a vehicle of type k;
w^{k} Energy recharging cost per unit of time for a vehicle of type k;
E^{k} Maximum energy capacity of a vehicle of type k;
Nb_{mod} Maximum number of modules to be added;
Variables
τᵢ Time variable specifying the time of arrival at destination location i;
yᵢ^{k} Variable specifying the remaining charge of vehicle k at destination location i;
lᵢ^{m} Variable specifying the remaining charge of module m at destination location i;
uᵢ^{k} Variable specifying the remaining load of vehicle k at destination location i;
gᵢ Random starting time at node i;
Decision variables
xᵢⱼ^{k} Equal to 1 if a vehicle of type k travels from destination location i to destination location j, 0 otherwise;
zᵢⱼ^{km} Equal to 1 if a vehicle of type k transports module m from node i to node j, 0 otherwise;
λᵢ^{m} Equal to 1 if destination location i is served by module m, 0 otherwise;
rᵢ^{k} Equal to 1 if a vehicle of type k recharges at destination location i, 0 otherwise.

5. The method of claim 4, wherein minimization of said objective function comprises using the central computation unit to:
draw S samples of said random variables, each sample being of size N and representing random arrival times at destination location and/or recharging locations, and storing said samples in a memory element;
compute S values of said objective function ƒ_{N}¹, ƒ_{N}², . . . ƒ_{N}^{S}, by solving the problem (1) repeatedly using a genetic algorithm;
compute an average value of the optimal solutions as
$$= \frac{1}{S} {\sum }_{S = 1}^{S} {f}_{N}^{S} ( {\tilde{x}}^{S} , {Sa}_{S} ( p ) ,$$
wherein \tilde{x}¹, \tilde{x}², . . . \tilde{x}^{S} are candidate solutions, and Saₕ(p) is the h-th sampling of the stochastic parameters.

6. The method of claim 1, wherein each modular vehicle transmits information providing an indication of the actual residual trailer module battery charge of each module to the central computation unit at least once as it drives in accordance with the delivery schedule.

7. The method of claim 1, wherein only data describing a specific vehicle's route, as provided by a computed delivery schedule, is transmitted to the corresponding vehicle.

8. The method of claim 1, further comprising the step of: autonomously driving the modular vehicle in accordance with said delivery schedule.

9. The method of claim 1, further comprising the step of: displaying at least part of said delivery schedule on a display unit in the modular vehicle.

10. The method of claim 1, wherein the indication of the corresponding actual travel times experienced by a respective vehicle is measured by a timing unit of the vehicle and transmitted to the central computing unit by the vehicle.

11. A computing device comprising a data processing unit, a data transmission unit and at least one memory element operatively connected to the data processing unit, wherein
data describing a fleet of modular electric vehicles, each vehicle comprising a propulsion module having an electric propulsion system and a propulsion battery, and a set of trailer modules, wherein each trailer module has a load capacity and a trailer module battery for providing electricity to said electric propulsion system, is provided in a memory element;
data describing a plurality of destination locations and destination time windows is provided in a memory element, wherein said trailer units are associated with said destination locations and time windows;
data describing a delivery schedule starting at a common depot location, such that each trailer module reaches their respective destination location within their respective destination time window given its available battery capacity is provided in a memory element;
wherein
the data transmission unit is configured to transmit at least part of said delivery schedule to the respective vehicles of the fleet;
and further wherein
the delivery schedule is based on random variables that represent the expected travel times between any two destination locations that are sequentially visited by a vehicle, and in that
the data processing unit is configured for updating said probability distributions of said random variables upon reception of an indication of the corresponding actual travel times experienced by said vehicles while driving in accordance with said delivery schedule, in order to take these travel times into account in future delivery schedule computations;
the data processing unit is configured for calculating at least one further delivery schedule after the probability distributions of said random variables have been updated, and for transmitting at least part of said delivery schedule to the respective vehicles of the fleet.

12. The computing device of claim 11, wherein the data processing unit is further configured to perform the method steps in accordance with claim 2.

13. A computer program comprising computer readable code, which when run on a computer, causes the computer to carry out the method according to claim 1.

14. A computer program product comprising a computer-readable medium on which the computer program according to claim 13 is stored.
